(19) United States
(12) Patent Application Publication
(10) Pub. No.: US 2013/0144986 A1
(43) Pub. Date: Jun. 6, 2013

(54) BROADCAST CONTENT TRANSMITTING APPARATUS AND BROADCAST CONTENT RECEIVING APPARATUS

(71) Applicants: Akira Yamada, Tokyo (JP); Tomoyuki Ohya, Tokyo (JP); Hosei Matsuoka, Tokyo (JP); Norihiko Nakazawa, Tokyo (JP); Masayuki Baba, Tokyo (JP)

(72) Inventors: Akira Yamada, Tokyo (JP); Tomoyuki Ohya, Tokyo (JP); Hosei Matsuoka, Tokyo (JP); Norihiko Nakazawa, Tokyo (JP); Masayuki Baba, Tokyo (JP)

(73) Assignees: MITSUBISHI ELECTRIC CORPORATION, Chiyoda-Ku, Tokyo (JP); NTT DOCOMO, INC., Tokyo (JP)

(21) Appl. No.: 13/701,029

(22) PCT Filed: May 30, 2011
(86) PCT No.: PCT/JP2011/062399

§ 371 Date: Feb. 21, 2013

(30) Foreign Application Priority Data
Jun. 4, 2010 (JP) 2010-128442

(51) Int. Cl. H04L 29/08

(52) U.S. Cl. CPC H04L 67/10
USPC 709/219

(57) ABSTRACT

When only part of content that is stored inside a terminal is updated, the updated content is allowed to be received efficiently, taking into account reducing the power consumption of the terminal. This broadcast content delivery apparatus (10) has a program information generating apparatus (15) that generates program information including a list of objects constituting the broadcast content, object identifiers, object version number information, and object broadcast times, and a content delivery control apparatus (12) that repeats transmitting the objects based on the object broadcast times, and transmits the program information at a predetermined transmission time, when there is addition, removal or updating with respect to the objects constituting the broadcast content, the program information of the broadcast content is updated, the updating of the objects is reported to a broadcast content receiving apparatus by updating corresponding object version number information, and the addition or removal of the objects is reported to the broadcast content receiving apparatus by updating the object list.

### TECHNICAL FIELD

The present invention relates to a broadcast content transmitting apparatus and a broadcast content receiving apparatus in a broadcast content distribution system which distributes content comprised of a plurality of objects.

### BACKGROUND ART

In terrestrial digital broadcasting, technologies related to distribution of storage-type content are being developed (see, for example, non-patent literature 1). Unlike stream-type content distribution, with storage-type content, non-real time-type file content is distributed by broadcast waves. A file group that is comprised of a plurality of storage-type files (hereinafter referred to as “objects”) will be referred to as “broadcast content.”

First, a receiver such as a user terminal acquires information (hereinafter referred to as program information) for displaying program information on the receiver via broadcast waves or communication waves. The program information can be transmitted by meta data (ECG meta data, transmission control meta data, and so on), an FDT instance, a manifest file and so on. In the program information, the broadcast times of a plurality of items of content and the identifiers for identifying the plurality of items of content (object IDs, session IDs, PIDs in the MPEG-2 systems, content URIs, content broadcast/viewing/available periods, broadcast complementing periods, and viewer attributes such as sex, age, time, preferences, and so on) are described.

Next, the user having the above terminal selects the desired content which the user wants to receive, from the above program information. The content is selected by means of a user interface provided on the terminal. By activating a broadcast wave receiving I/F at the time described in the program information, the terminal receives and stores the selected content in the terminal. The content is stored in the terminal, so that the user is able to view the content when complementing the missing or damaged packets is finished, or while complementing packets.

Upon content distribution, if it is possible to distribute a plurality of objects (items of content) to a terminal, store the objects in the terminal, and change the object to display as appropriate, services of better convenience are possible. For example, it may become possible to display an optimal advertisement to the terminal from the plurality of objects, depending on the attributes of the user (sex, age, time, preferences and so on).

### CITATION LIST

### Non-Patent Literature

Non-Patent Literature 1: ETSI TS102 591

### SUMMARY OF INVENTION

### Technical Problem

However, when only part of the objects with respect to the content stored in a terminal is updated, there is no established technique to report to the terminal which object is updated. Accompanying the updating of part of the objects, it is possible to re-distribute and update the whole content, but there is a problem that the terminal's power consumption for receiving the whole content increases.

The present invention has been made in view of the above, and it is therefore an object of the present invention to provide a broadcast content transmitting apparatus and a broadcast content receiving apparatus whereby, when only part of the content that is stored inside a terminal is updated, it is possible to allow the updated content to be received effectively, taking into account reducing the power consumption of the terminal.

### Solution to Problem

A broadcast content transmitting apparatus according to the present invention has: a program information generating section that, with respect to broadcast content that is comprised of a plurality of objects, generates program information, including a list of objects constituting the broadcast content, object identifiers, object version number information and object transmission times; a content delivery control section that repeats transmitting the objects based on the object broadcast times, and also transmits the program information at a predetermined transmission time; and an updating section that, when there is addition, removal or updating with respect to the objects constituting the broadcast content, updates the program information of the broadcast content, and, in this broadcast content transmitting apparatus, the updating of the objects is reported to a broadcast content receiving apparatus by updating corresponding object version number information; and the addition or removal of the objects is reported to the broadcast content receiving apparatus by updating the object list.

According to this configuration, when there is addition or removal with respect to the objects constituting the content, the objects on the object list are added or removed and the program information after the change is transmitted, so that a broadcast content receiving apparatus receiving the program information after the change is able to detect addition or removal of objects from the program information after the change, receive only the added objects in accordance with the object transmission times, and remove the removed objects from the stored content. Also, when there is an updated object, the object version number information in the program information is updated and the updated program information is transmitted, so that the broadcast content receiving apparatus receiving the updated program information is able to receive and store only the updated object.

In the above broadcast content transmitting apparatus, the broadcast content delivery control section transmits the objects in order from a newest object that is added or updated.

According to this configuration, the user is able to distribute, in order, from the content (object) that is added or updated and that is highly requested to be received and that the user requests highly.

The above broadcast content is advertisement broadcast content that is comprised of advertisement objects, where each object is formed with a commercial message. Furthermore, the above broadcast content is program information content that is comprised of program information objects, where each object is formed with program information. Furthermore, the above broadcast content is media content that is comprised of media objects, where each object is formed with a media file.

In the above broadcast content transmitting apparatus, the program information generating section generates program information related to the program information content and program information related to each content corresponding to each program information object, and the content delivery control section transmits the program information related to the program information content and the program information related to each content corresponding to each program information object, at respective transmission times.

According to this configuration, when, for example, it is necessary to distribute a plurality of items of program information corresponding to a plurality of items of broadcast content, in addition to distributing program information related to advertisement broadcast content, it is possible to distribute the program information of the program information, and a terminal receiving the program information of the program information is able to selectively receive only the program information that is added or updated. Also, by receiving from content (object) that is highly requested by the user, the receiver is able to receive content continuously, and reduce the number of times to turn on and off the receiver.

A broadcast content receiving apparatus according to the present invention has: a receiving section that receives program information including an object list of objects constituting broadcast content, object identifiers, object version number information and object broadcast times, and also receives the objects included in the object list of the program information based on the object broadcast times; a memory that stores the broadcast content received in the receiving section in object units, and program information related to the broadcast content; and a control section that detects updating of the objects from the object version number information included in newest program information that is stored in the memory, detects addition or removal of the objects from the object list, and controls the receiving section to receive only an object that is detected to be updated or added, among a plurality of objects constituting the broadcast content, at an object broadcast time of the object.

According to this configuration, among a plurality of objects constituting the broadcast content, only an object that is detected to be updated or added can be received at the object broadcast time of the object, so that, when only part of the content that is stored inside a terminal is updated, it is possible to allow the updated content to be received effectively, taking into account reducing the power consumption of the terminal.

In the above broadcast content receiving apparatus, when the objects are transmitted from a broadcast content transmitting apparatus in order from the updated or added object, the receiving section receives only an object that needs to be updated or added, under control of the control section.

In the above broadcast content receiving apparatus, the receiving section receives program information related to program information content that is comprised of program information objects, where each object is formed with program information, and program information related to each content corresponding to each program information object, and, when program information that is added or updated is detected from the program information related to the program information content, the control section controls the receiving section to receive the added or updated program information based on a transmission time of the detected program information.

### Advantageous Effects of Invention

According to the present invention, when only part of the content that is stored inside a terminal is updated, it is possible to allow the updated content to be received efficiently, taking into account reducing the power consumption of the terminal.

### BRIEF DESCRIPTION OF DRAWINGS

FIG. 1 is an overview of a broadcast system according to an embodiment;

FIG. 2A is a diagram showing an object configuration example of advertisement broadcast content, and FIG. 2B is a diagram showing an object configuration example of program information content;

FIG. 3 is a configuration diagram of a broadcast receiving terminal;

FIG. 4 is a diagram showing a configuration example program information to be distributed on April 6;

FIG. 5 is a diagram showing a configuration example of program information to be distributed on April 7;

FIG. 6 is a diagram showing the steps of generating objects (content);

FIG. 7 is a diagram showing other steps of generating objects (content);

FIG. 8 is a diagram showing an overall process flow in a content delivery apparatus;

FIG. 9 is a diagram showing program information received in a broadcast receiving terminal on March 10;

FIG. 10 is a conceptual diagram showing a transmission order of objects; and

FIG. 11 is a diagram showing an overall process flow in a broadcast receiving terminal.

### DESCRIPTION OF EMBODIMENTS

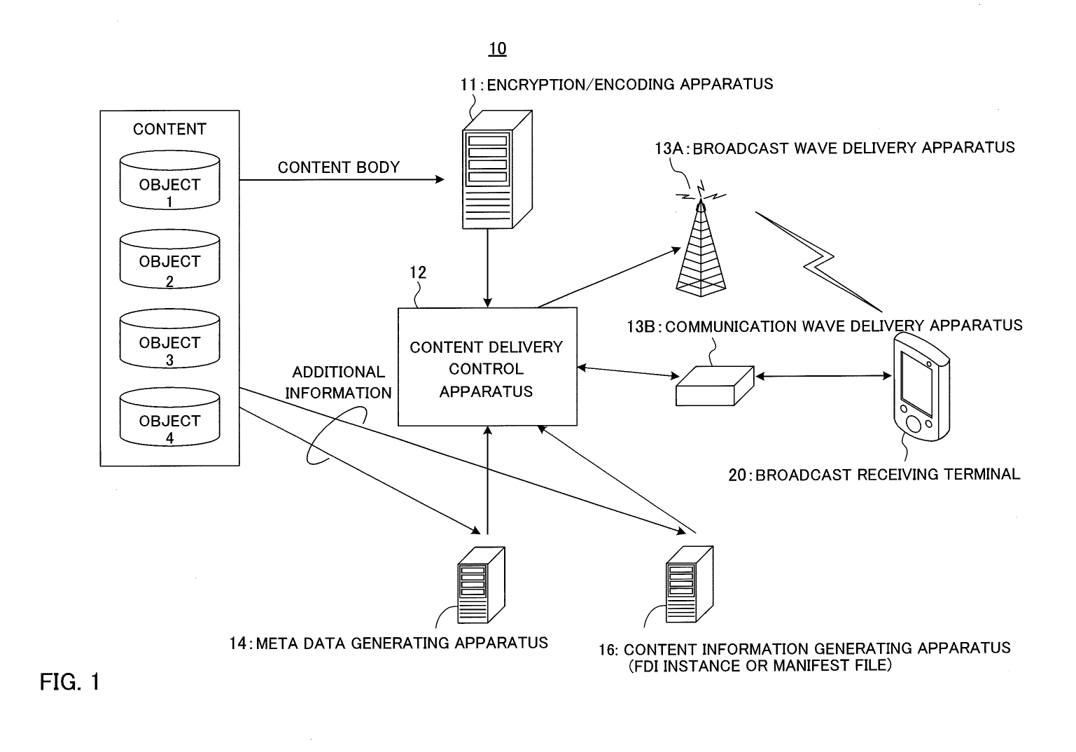

Now, embodiments of the present invention will be described below in detail with reference to the accompanying drawings. FIG. 1 is an overview of a broadcast system according to the present embodiment. As shown in the drawing, the broadcast system of the present embodiment is comprised of a content delivery apparatus 10, which serves as a broadcast content transmitting apparatus that broadcasts broadcast content and program information, a broadcast receiving terminal 20, which serves as a broadcast content receiving apparatus that receives and stores the broadcast content and program information delivered from the content delivery apparatus 10, and a broadcasting/communication infra-structure apparatus that transmits the broadcast waves or communication waves delivered from the content delivery apparatus 10, to the broadcast receiving terminal 20.

The content delivery apparatus 10 has an encryption/decoding apparatus 11 that encrypts and encodes the content body constituting the broadcast content, a content delivery control apparatus 12 that encrypts, encodes and delivers the objects constituting the broadcast content at the object transmission time, a broadcast wave delivery apparatus 13A that transmits the objects and program information delivered from the content delivery control apparatus 12 by broadcast waves, and a communication wave delivery apparatus 13B that transmits the program information delivered from the content delivery control apparatus 12 by communication waves. Also, the content delivery apparatus 10 has a meta data generating apparatus 14 that generates broadcast content meta data (ECG meta data, transmission control meta data and so on), and a content information generating apparatus 16 that generates a manifest file or an FDT instance, which is one type of program information.

The broadcast content that is broadcast from the content delivery apparatus 10 is a file group that is comprised of a plurality of objects, which are a plurality of storage-type files. An example is shown in FIG. 1 where one broadcast content is comprised of four objects 1 to 4.

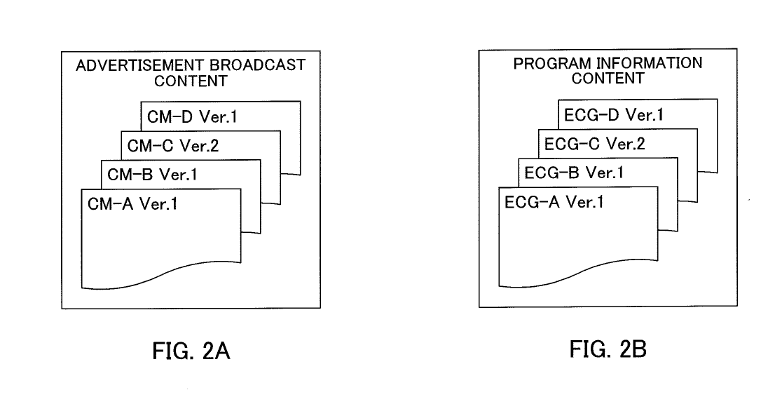

FIG. 2A shows an object configuration example of advertisement broadcast content. The advertisement broadcast content is comprised of advertisement objects, where each object is formed with a commercial message (file format). Although the commercial messages CM-A, CM-B and CM-D, have a version number of “Ver. 1,” the commercial message CM-C alone has a version number of “Ver. 2.” In this way, version-up of advertisement objects in object units is possible. The broadcast receiving terminal 20 receives the commercial messages CM-A to CM-D by broadcast waves, stores the commercial messages CM-A to CM-D in a memory, and displays the commercial messages CM-A to CM-D to the user at appropriate timing.

FIG. 2B shows an object configuration example of program information content. The program information content is comprised of program information objects, where each object is formed with an ECG. The program information content functions as “program information of program information.” With individual ECG-A to ECG-D, each ECG itself has a transmission time and a version number, so that, given that an ECG may be added or removed, one ECG can be used as an object. By distributing the program information content to the broadcast receiving terminal 20, the broadcast receiving terminal 20 is able to receive only the necessary program information, so that it is possible to reduce the load of the broadcast receiving terminal 20.

Here, program information that is generated in the meta data generating apparatus 14 and the content information generating apparatus 16 will be described. The program information related to advertisement broadcast content, shown in FIG. 2A, is formed to include an object list, which is a list of commercial messages CM-A to CM-D (objects) that are planned to be distributed, the identifiers of the commercial messages CM-A to CM-D, the version numbers, which are information about the version numbers of the commercial messages CM-A to CM-D, the broadcast times of the commercial messages CM-A to CM-D, and the URIs of the commercial messages CM-A to CM-D objects. The meta data generating apparatus 14 generates program information from additional information that is set in advance in the commercial messages CM-A to CM-D, object IDs, session IDs, PIDs in the MPEG-2 systems, content URIs, content broadcast/viewing/available periods, broadcast complementing periods, viewer attributes such as sex, age, time and preferences, and requirement conditions of the broadcast station and the content provider.

The program information related to program information content, shown in FIG. 2B, is formed to include a plurality of, or part of, a program information object list, which is a list of individual program information objects ECG-A to ECG-D generated in the meta data generating apparatus 14, the identifiers of ECG-A to ECG-D, the version numbers, which are the version number information of ECG-A to ECG-D, the broadcast times of ECG-A to ECG-D, the object IDs of ECG-A to ECG-D, session IDs, PIDs in the MPEG-2 Systems, content URIs, content broadcast/viewing/available periods, broadcast complementing periods, and view attributes such as sex, age, time, and preferences. Based on the additional information of the individual program information objects ECG-A to ECG-D generated in the meta data generating apparatus 14, the content information generating apparatus 16 generates program information that is formed with a list of ECG-A to ECG-D, the identifiers of ECG-A to ECG-D, the version information of ECG-A to ECG-D and the broadcast time information of ECG-A to ECG-D.

The meta data generating apparatus 14 and the content information generating apparatus 16 detects addition, removal and update of objects, from the additional information of the objects constituting the broadcast content (commercial messages CM-A to CM-D/ECG-A to ECG-D), and has the addition, removal and update of objects upon the program information that is provided to generate program information in the receiver. To be more specific, for example, when an object is added to broadcast content, the added object is added to an object list, which includes a plurality of or part of ECG meta data, transmission control meta data, a manifest file, an FDT instance, and transmission control meta data, and the identifier of the added object, the version information of the added object, and the broadcast time of the added object are described. Also, when one of the objects constituting the content is removed, the object of the target of removal is removed from the object list of the program information, and the identifier of the removal target object, the version information of the removal target object, and the broadcast time of the removal target object are removed. Furthermore, when one of the objects constituting the content is updated, the version information of the object of the target of the updating is changed to an updated version number. In this way, the content information generating apparatus 16 functions as a program information generating section to generate program information, and also functions as an updating section to reflect the addition, removal and update of objects upon the program information.

The content delivery control apparatus 12 transmits the objects constituting the broadcast content at the object broadcast time described in the program information. At this time, it is preferable that the objects are transmitted in order from the new, updated object. The order of transmission of the objects will be described in detail.

The content delivery control apparatus 12 transmits the program information at a predetermined transmission time. The program information may be transmitted on a regular basis at predetermined time intervals, or may be transmitted in a predetermined time range. Furthermore, program information may be transmitted on an irregular basis, triggered by, for example, occurrence of an event such as addition, removal and update of an object. Also, program information may be transmitted by broadcast waves or may be transmitted by communication waves other than broadcast waves. Alternatively, it is also possible to transmit the program information generated by the meta data generating apparatus 14 by broadcast waves and transmit the program information generated by the content information generating apparatus 16 by communication waves. Alternatively, it is also possible to report a predetermined time range to the receiver in advance by transmission control meta data. Also, when program information is transmitted as transmission control meta data, the program information is delivered before the broadcast content is broadcast, so that, when the content is broadcast, the receiver is able to receive only at the broadcast time of specific objects. Also, when program information is transmitted by an FDT instance, the receiver is able to receive a specific object by receiving the FDT instance when the content is broadcast, reading the broadcast time of the specific object from the FDT instance and receiving at that time again. By not receiving during the broadcast times other than the broadcast time of the specific object, it is possible to reduce the power consumption of the receiver.

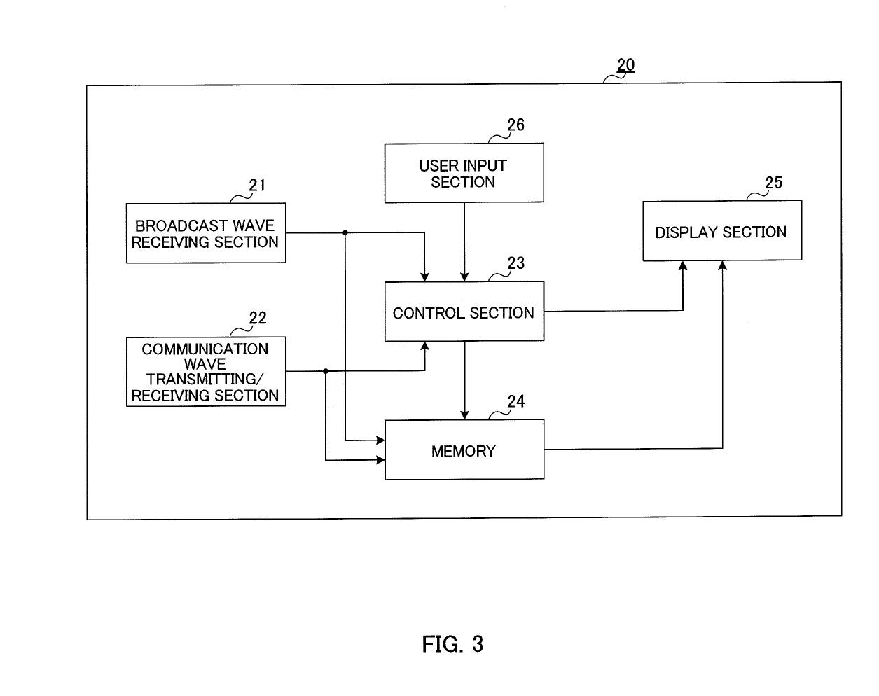

FIG. 3 is a configuration diagram of a broadcast receiving terminal 20. The broadcast receiving terminal 20 has a broadcast wave receiving section 21 that receives broadcast waves, and a communication wave transmitting and receiving section 22 that transmits and receives communication waves. The broadcast wave receiving section 21 and the communication wave transmitting and receiving section 22 constitute a receiving section that receives content and program information. The broadcast wave receiving section 21 has a function for receiving terrestrial digital broadcast waves and receiving the broadcast waves transmitted from the broadcast wave delivery apparatus 13A. The communication wave transmitting and receiving section 22 has a radio or cable communication section that transmits and receives communication waves other than broadcast waves (for example, mobile telephone network, wireless LAN, WiMAX, internet channel and so on), and, when program information is delivered from the content delivery control apparatus 12, receives the program information. Also, when there is a missing or damaged packet in the received broadcast content, the communication wave transmitting and receiving section 22 delivers a communication wave to request retransmission to the content delivery apparatus 10, and receives the packet retransmitted by a communication wave from the content delivery apparatus 10.

The broadcast receiving terminal 20 has a control section 23 which has a function of controlling reception time in the broadcast wave receiving section 21 and the communication wave transmitting and receiving section 22. The control section 23 is comprised of hardware such as a CPU, a RAM, a ROM, and other integrated circuits (DSP and so on), so that the CPU reads the software program stored in the RAM or the ROM, and the hardware and the software program cooperate to realize the control functions, which will be described later. The memory 24 stores the broadcast content (objects) and the program information received by the broadcast wave receiving section 21 and the communication wave transmitting and receiving section 22 under the control of the control section 23.

The control section 23 controls the operations for, for example, making the broadcast wave receiving section 21 or the communication wave transmitting and receiving section 22 receive the content at the broadcast times described in the program information (including the activation timing).

Also, the control section 23 recognizes the transmission time of an added or updated object from the received program information, and makes the broadcast wave receiving section 21 or the communication wave transmitting and receiving section 22 receive the content at the transmission time of the added or updated object.

Also, the control section 23 recognizes the removed object from the received program information and removes the object that is removed from the program information from the memory. The user input section 26 provides a user interface function for content selection, for selecting the broadcast content which the user desires. The display section 25 and the user input section 26 may be integrated as hardware, like a touch panel. In the state in which program information is displayed on the display section 25, if the user touches arbitrary content from the program information on the display section 25, and the selected content information is input in the control section 23. The control section 23 receives the selected content by activating the broadcast wave receiving section 21 at the object transmission time described in the program information table.

Next, the operations in the broadcast system configured as described above will be described. Assume that, advertisement broadcast content that is comprised of a plurality of commercial messages CM-A to CM-E is distributed as broadcast content. The meta data generating apparatus 14 generates program information based on additional information of the objects constituting the advertisement broadcast content (a plurality of commercial messages CM-A to CM-E).

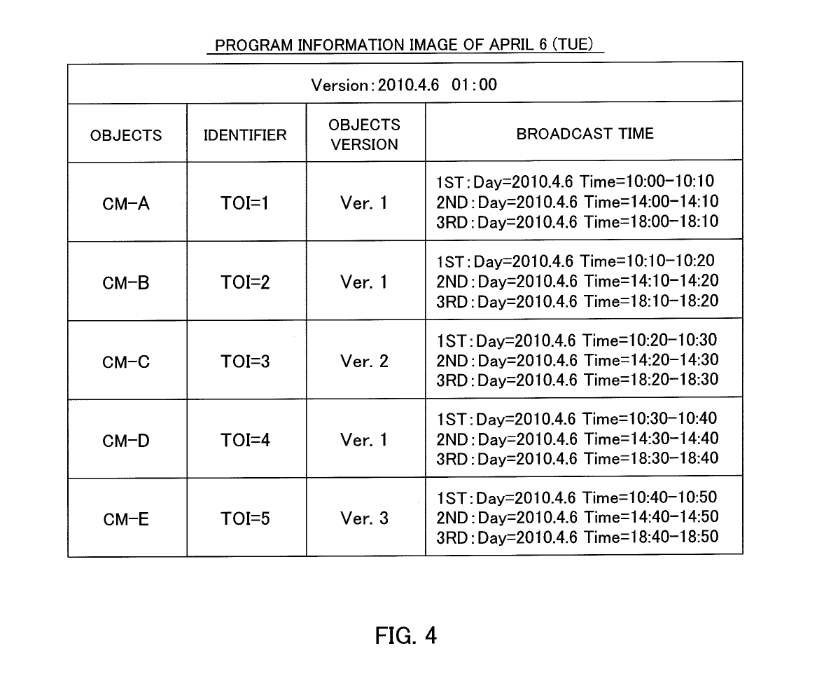

FIG. 4 is a configuration example of program information to be distributed on April 6. As shown in this drawing, program information that is comprised of an object list of a plurality of commercial messages CM-A to CM-E constituting the advertisement broadcast content, the identifiers of the commercial messages CM-A to CM-E to be objects, the version numbers, and the broadcast times, is included. Also, the version number (version: 2010.4.6 01:00) of the program information itself is attached to the program information. According to the program information shown in this drawing, the objects (the commercial messages CM-A to CM-E) are each broadcast three times a day. The content delivery control apparatus 12 reads this program information from the memory (not shown) of the content delivery apparatus 10, at 2010.4.6 01:00, which is defined as the transmission time for that program information, and broadcasts and transmits the program information from the broadcast wave delivery apparatus 13A. Alternatively, the content delivery control apparatus 12 delivers the program information from the communication wave delivery apparatus 13B by communication waves.

Also, it is possible to include URI information of each object in the program information and transmit this program information. This URI is information, also described in the transmission control meta data or in the FDT instance, has a role of connecting between the ECG meta data and the actual objects.

The program information to include the program information, the version information, the transmission times, the content URIs and so on can be transmitted by other methods as well. For example, it is equally possible to include and transmit program information in the FileContent-Location element in the FDT Instance in the same session. In this case, the version information can be included in the TOI bit sequence (for example, the lower N bits when the Version-ID-Length is N bits) in the FileContent-Location element, and transmitted.

Also, it is equally possible to include and transmit the same information in the manifest file, which is transmitted with the content, or in the transmission control meta data to be transmitted in a separate session.

When program information is transmitted by broadcast waves from the content delivery apparatus 10, the broadcast receiving terminal 20 receives the program information in the broadcast wave receiving section 21 and stores the program information in the memory 24 under the control of the control section 23. Alternatively, when the content delivery apparatus 10 transmits program information by communication waves, the broadcast receiving terminal 20 receives the program information in the communication wave transmitting and receiving section 22 and stores the program information in the memory 24 under the control of the control section 23.

As described above, before content is distributed by the content delivery apparatus 10, program information that relates to the content is stored in the broadcast receiving terminal 20.

Meanwhile, at the broadcast times of objects (the commercial messages CM-A to CM-E) described in the program information shown in FIG. 4, the content delivery apparatus 10 transmits the corresponding objects (encrypted and encoded) from the broadcast wave delivery apparatus 13 by broadcast waves. For example, with the commercial message CM-A, broadcast is repeated three times at 10:00 am, 14:00 pm, and 18:00 pm of April 6.

The broadcast receiving terminal 20 holds program information that is distributed in advance, prior to content distribution. The control section 23 memorizes the content, for which the user inputs a request to receive, from the user input section 26, and determines the reception schedule from the transmission time of the object and manages the reception schedule. The control section 23 is activated at the transmission time of each content, based on the reception schedule determined based on the program information, receives the object in the broadcast wave receiving section 21, and stores the object in the memory 24 under the control of the control section 23. The objects described in the object list of the program information are received sequentially at the object broadcast time of each object. For example, as shown in FIG. 4, when a plurality of objects to constitute the content are consecutive, the broadcast receiving terminal 20, once activated, can receive the objects continuously.

In this way, the program information shown in FIG. 4 and broadcast content corresponding to that program information are stored in the memory 24 of the broadcast receiving terminal 20.

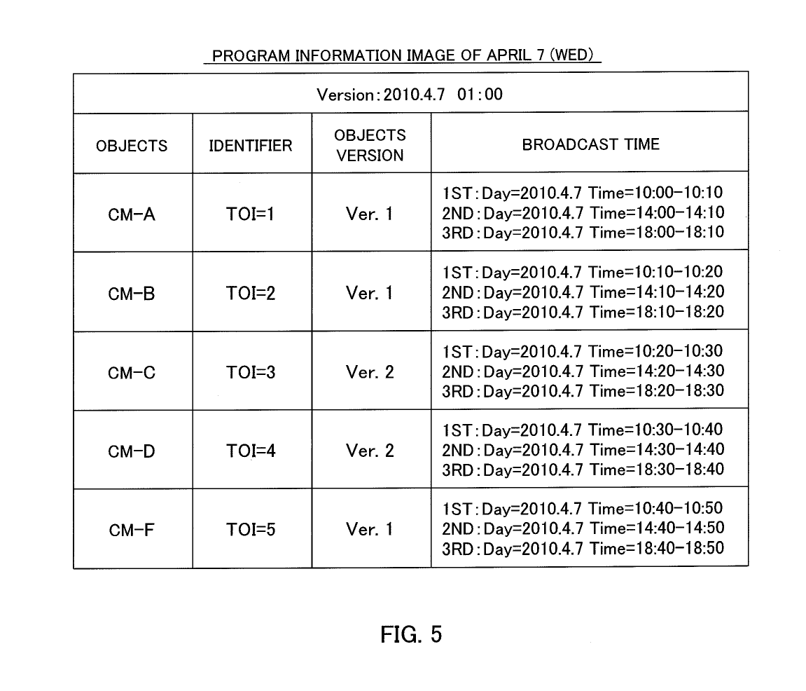

FIG. 5 shows a configuration example of program information to distribute on April 7. This is an updated version of the program information distributed on April 6, shown in FIG. 4. As shown in the drawing, the commercial message CM-E is removed from the broadcast content, and the version number of the commercial message CM-D is updated. The version number of the program information itself is changed. The version number of the program information itself is updated to “version: 2010.4.7 01:00.”

The content delivery control apparatus 12 reads the updated program information shown in FIG. 5, from the memory (not shown) of the content delivery apparatus 10, at 2010.4.7 01:00, which is defined as the transmission time of that program information, and transmits the program information from the broadcast wave delivery apparatus 13A by broadcast waves or transmits the program information from the communication wave delivery apparatus 13B by communication waves.

The broadcast receiving terminal 20 receives the updated program information that is transmitted from the content delivery apparatus 10 by the broadcast wave receiving section 21 or by the communication wave transmitting and receiving section 22, and stores the program information in the memory 24 under the control of the control section 23.

Upon receiving program information that relates to the same content as the content that is already stored, the control section 23 stores the difference of the program information. In this case, it is detected that the version number of the commercial message CM-D is increased, that the commercial message CM-E is removed, and that the commercial message CM-F is added. The control section 23 can also identify updating of program information using a hash function and so on such as MD5, created from the program information.

Compared to the program information (one of or a plurality of the ECG meta data, the transmission control meta data, the FDT instance and the manifest file), including the broadcast times, object IDs, URIs and so on of content (objects) received in advance, the control section 23 executes the updating process (addition, removal and update of an object) of the stored content (objects) in accordance with the newly received program information. That is to say, the commercial message CM-E that is removed from the object list is removed from the content stored in the memory. Also, the added or updated object is newly received. Consequently, the control section 23 acquires the transmission time of the added or updated object from the newly received program information, and performs schedule management of the transmission time of the added or updated object. The control section 23 is activated at the transmission time of the added or updated content, based on the program information, receives the corresponding object in the broadcast wave receiving section 21, and stores the object in the memory 24 under the control of the control section 23. In the case of the program information shown in FIG. 5, the control section 23 is activated at 10:30 am of April 7, receives the commercial message CM-D and receives the commercial message CM-F that is broadcast following the commercial message CM-D. The updated commercial message CM-D overwrites the commercial message CM-D of the older version, and the added commercial message CM-F is additionally stored in the content. The broadcast receiving terminal 20 has only to receive the updated commercial message CM-D and the added commercial message CM-F on April 7, so that, compared to the situation where, when only one object is updated, all the objects constituting the content have to be received again, the processing load is reduced significantly.

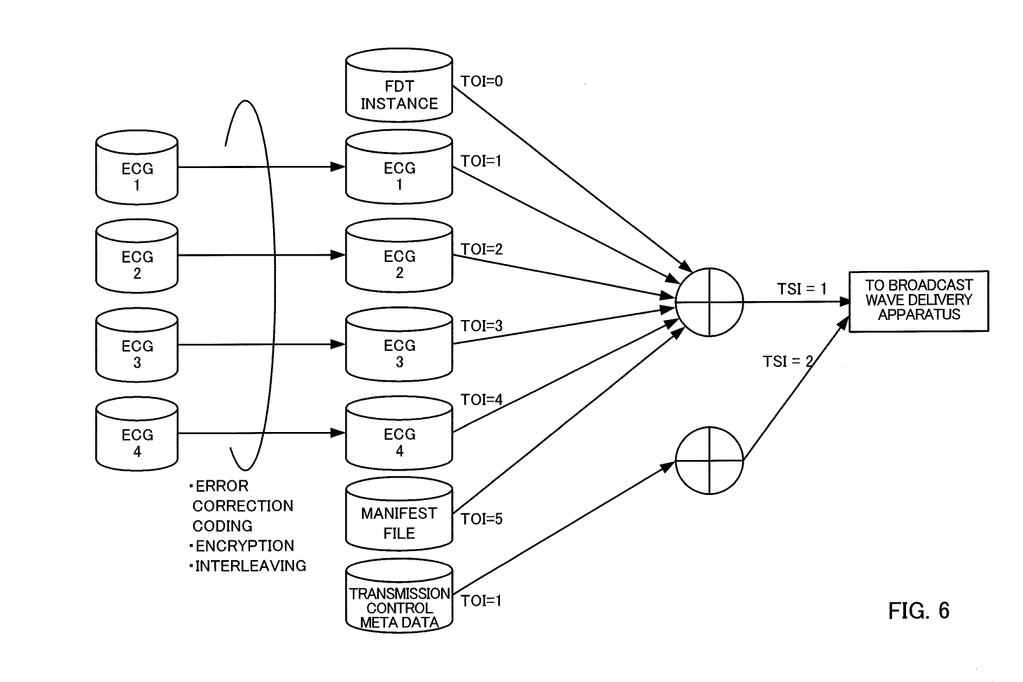

FIG. 6 shows the steps of generating objects (content). In the example shown in the drawing, a plurality of program information objects (ECGs) are the broadcast content. The program information content is comprised of four ECGs, namely ECG 1 to ECG 4. The content delivery control apparatus 12 transmits a plurality of objects ECG 1 to ECG 4, a manifest file which serves as the program information of these objects ECG 1 to ECG 4, an FDT instance, and transmission control meta data, in different FULUTE (File Delivery over Unidirectional Transport) sessions. FLUTE is the communication protocol defined by the IETF (Internet Engineering Task Force) (RFC 3926), and is a communication protocol that can distribute data using a one-way transmission path (for example, a downlink-only transmission path). The FDT instance is detailed information of the objects to be transmitted by ALC (Asynchronous Layered Coding), and is transmitted in the same session as the download session in which content is transmitted. The transmission control meta data includes types such as Session Description, Associated Delivery Procedure Description and so on. Session Description holds download transmission method-specific information to be used in user services. Associated Delivery Procedure Description defines the process which the receiver executes after content is transmitted in the file casting service. The file repairing step for when missing or damaged packets are detected in the download transmission method, and the reception reporting step of reporting that content reception by the download transmission method is complete, are included. As shown in FIG. 6, identifiers (TOI=0 to TOI=5) are attached to the data (the objects, the FDT instance, the transmission control meta data and so on) to be transmitted in FULUTE sessions.

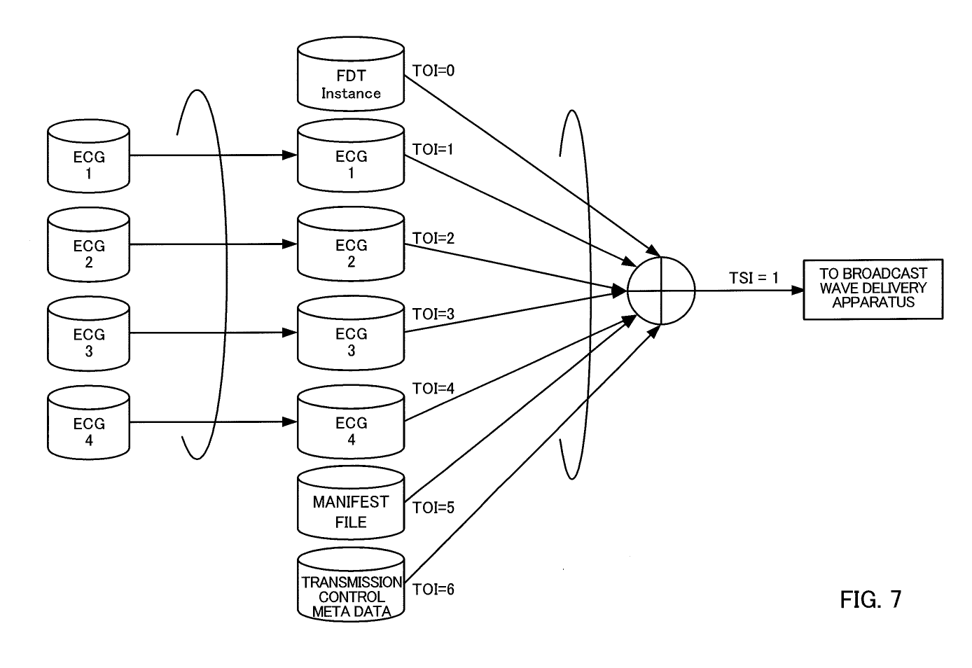

FIG. 7 is a modification example of the embodiment of FIG. 6. In this example, all objects are transmitted in the same session.

Note that FIG. 6 and FIG. 7 show examples where the objects to transmit are ECG meta data. As described above, the objects to transmit may be advertisement objects (FIG. 2A) or may be objects other than advertisement.

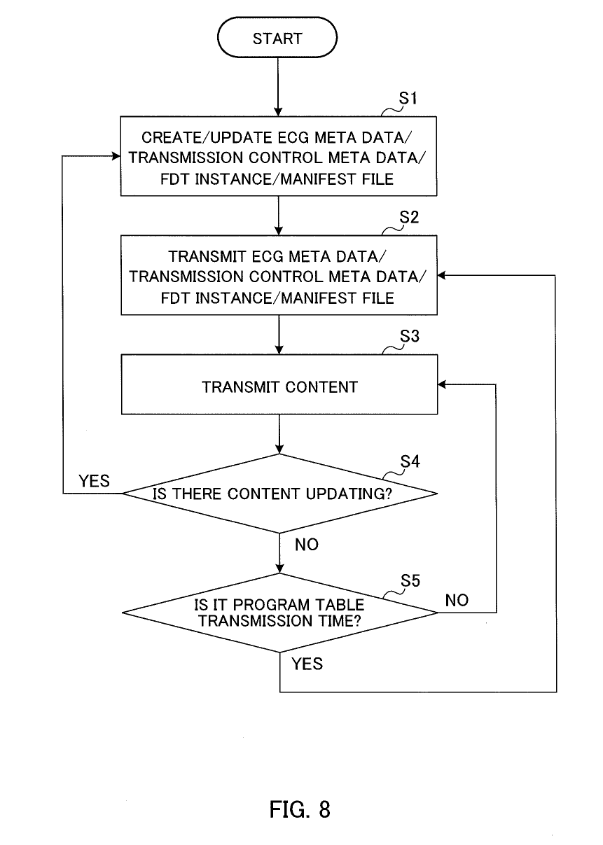

FIG. 8 shows an overall process flow for transmission of program information and content in the content delivery apparatus 10. In accordance with addition, removal and updating of objects, the ECG meta data, the transmission control meta data, the manifest file, and the FDT instance are newly created or updated (step S1, and at the respective transmission times, the ECG meta data, the transmission control meta data, the manifest file and the FDT instance are transmitted by broadcast waves or transmitted by communication waves (step S2). Also, at the object transmission timed described in the program information, the transmission control meta data, the manifest file and the FDT instance, the objects (content) are transmitted (step S3). The step shifts to step S1 if content updating occurs (step S4), or the step shifts to step S2 at the program table transmission time if there is no updating of the content (step S5). The step shifts to step S3 until the transmission time.

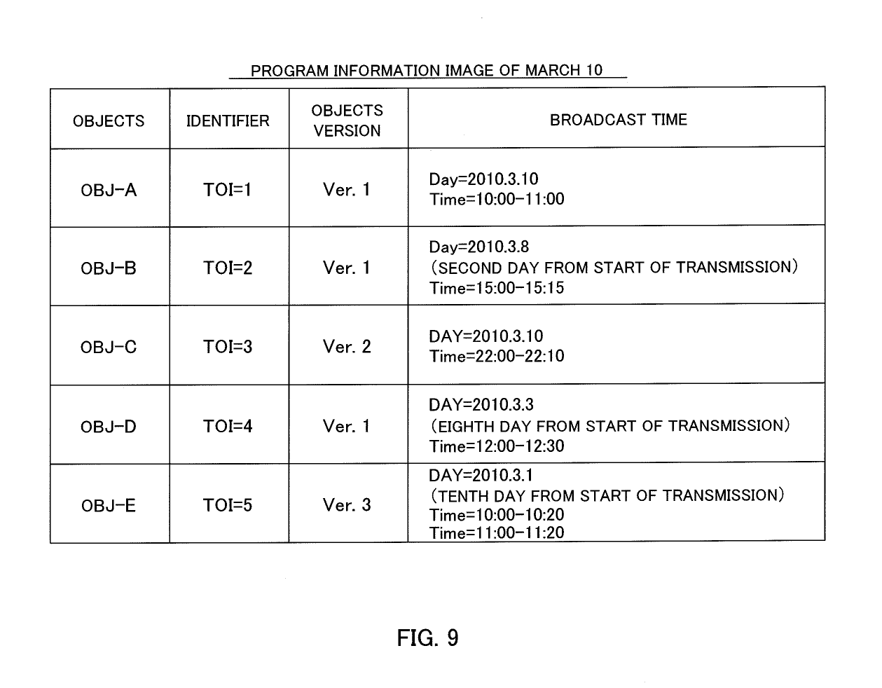

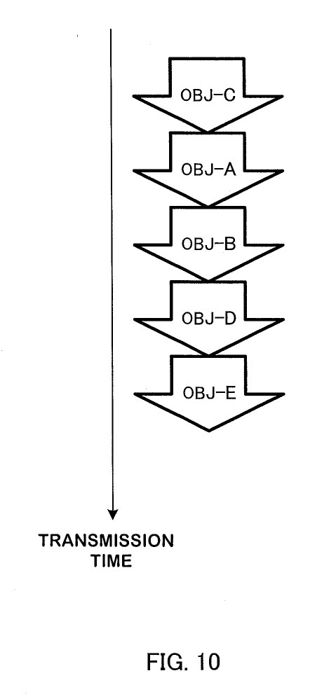

With the present embodiment, the content delivery control section 12 transmits the objects sequentially, from the newest object that is added or updated. For example, assume that the program information shown in FIG. 9 is received by the broadcast receiving terminal 20 on March 10. The program information shows the names of the objects, the identifiers of the objects, the TOIs (Transmission Object IDs) that are attached to the headers and so on upon transmission, the version information of the objects, and the broadcast times. As of March 10, it is clear that OBJ-E is the oldest, and the objects are updated sequentially in the order of D, B, A and C. Given that OBJ-C is the newest and there is a high possibility that updating is required on the terminal side, as shown in FIG. 10, the objects are transmitted, from OBJ-C, up to OBJ-E, in order. By this means, it is possible to distribute the objects preferentially from the updated (or added) object, which is estimated to be the object that is requested the most by the broadcast receiving terminal 20.

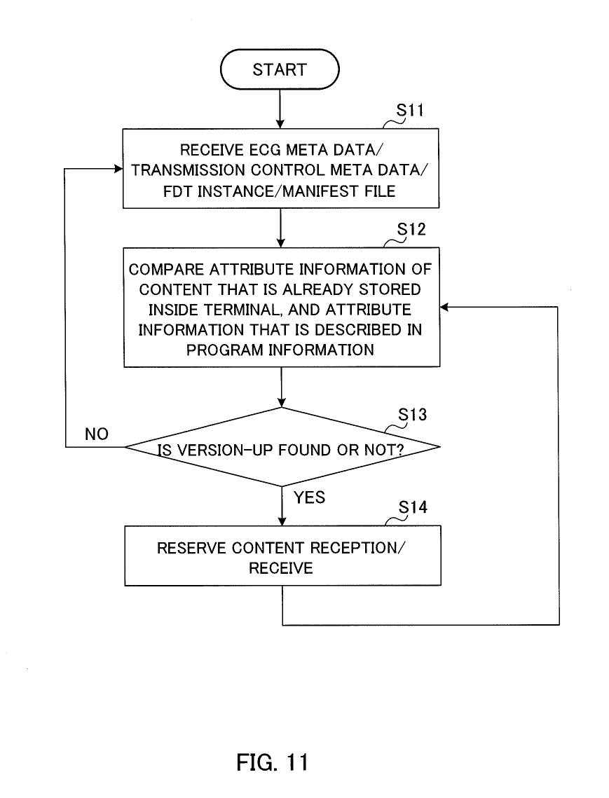

FIG. 11 shows an overall process flow for receiving program information and content in the broadcast receiving terminal 20. Program information related to the content, the transmission control meta data, or the manifest file is received (step S11), and the attribute information of the content that is already stored in the terminal (see the program information that is received earlier), and the attribute information (the version numbers, the identifiers, and so on) that is received presently, are compared (step S12). If version-up of an object is found from the version number of the corresponding object (step S13), reception is reserved based on the transmission time of the version-up object (reception schedule management), and, upon activation at the transmission time, the object is received (step S14).

By this means, it is possible to realize power consumption reduction of the broadcast receiving terminal 20 and execute content updating effectively.

### INDUSTRIAL APPLICABILITY

The present invention is applicable to broadcast content distribution systems to transmit content that is comprised of a plurality of objects.

The disclosure of Japanese Patent Application No. 2010-128442, filed on Jun. 4, 2010, including the specification, drawings, and abstract, is incorporated herein by reference in its entirety.

1. A broadcast content transmitting apparatus comprising:
a program information generating section that, with respect to broadcast content that is comprised of a plurality of objects, generates program information, including a list of objects constituting the broadcast content, object identifiers, object version number information and object transmission times;
a content delivery control section that repeats transmitting the objects based on the object broadcast times, and also transmits the program information at a predetermined transmission time; and
an updating section that, when there is addition, removal or updating with respect to the objects constituting the broadcast content, updates the program information of the broadcast content, wherein:
the updating of the objects is reported to a broadcast content receiving apparatus by updating corresponding object version number information; and
the addition or removal of the objects is reported to the broadcast content receiving apparatus by updating the object list.

2. The broadcast content transmitting apparatus according to claim 1, wherein the broadcast content delivery control section transmits the objects in order from a newest object that is added or updated.

3. The broadcast content transmitting apparatus according to claim 1, wherein the broadcast content is advertisement broadcast content that is comprised of advertisement objects, where each object is formed with a commercial message.

4. The broadcast content transmitting apparatus according to claim 1, wherein the broadcast content is media content that is comprised of media objects, where each object is formed with a media file.

5. The broadcast content transmitting apparatus according to claim 1, wherein the broadcast content is program information content that is comprised of program information objects, where each object is formed with program information.

6. The broadcast content transmitting apparatus according to claim 5, wherein:
the program information generating section generates program information related to the program information content and program information related to each content corresponding to each program information object; and
the content delivery control section transmits the program information related to the program information content and the program information related to each content corresponding to each program information object, at respective transmission times.

7. A broadcast content receiving apparatus comprising:
a receiving section that receives program information including an object list of objects constituting broadcast content, object identifiers, object version number information and object broadcast times, and also receives the objects included in the object list of the program information based on the object broadcast times;
a memory that stores the broadcast content received in the receiving section in object units, and program information related to the broadcast content; and
a control section that detects updating of the objects from the object version number information included in newest program information that is stored in the memory, detects addition or removal of the objects from the object list, and controls the receiving section to receive only an object that is detected to be updated or added, among a plurality of objects constituting the broadcast content, at an object broadcast time of the object.

8. The broadcast content receiving apparatus according to claim 7, wherein, when the objects are transmitted from a broadcast content transmitting apparatus in order from the updated or added object, the receiving section receives only an object that needs to be updated or added, under control of the control section.

9. The broadcast content receiving apparatus according to claim 7, wherein:
the receiving section receives program information related to program information content that is comprised of program information objects, where each object is formed with program information, and program information related to each content corresponding to each program information object; and
when program information that is added or updated is detected from the program information related to the program information content, the control section controls the receiving section to receive the added or updated program information based on a transmission time of the detected program information.

10. A broadcast content transmitting method comprising the steps of:
with respect to broadcast content that is comprised of a plurality of objects, generating program information, including a list of objects constituting the broadcast content, object identifiers, object version number information and object transmission times;
repeating transmitting the objects based on the object broadcast times, and also transmitting the program information at a predetermined transmission time; and
when there is addition, removal or updating with respect to the objects constituting the broadcast content, updating the program information of the broadcast content, wherein:
the updating of the objects is reported to a broadcast content receiving apparatus by updating corresponding object version number information; and
the addition or removal of the objects is reported to the broadcast content receiving apparatus by updating the object list.

11. A broadcast content receiving method comprising:
receiving program information including an object list of objects constituting broadcast content, object identifiers, object version number information and object broadcast times, and also receiving the objects included in the object list of the program information based on the object broadcast times;
storing the broadcast content received in object units, and program information related to the broadcast content; and
detecting updating of the objects from the object version number information included in newest program information that is stored, detecting addition or removal of the objects from the object list, and controlling a reception start time such that only an object that is detected to be updated or added is received, among a plurality of objects constituting the broadcast content, at an object broadcast time of the object.
